(19) United States
(12) Patent Application Publication
(10) Pub. No.: US 2026/0358772 A1
(43) Pub. Date: Nov. 12, 2026

(54) BUILDING MANAGEMENT AND AUTOMATION SYSTEM

(71) Applicant: Conti, LLC, Sterling Hts, MI (US)

(72) Inventor: Mitchell Reed, Sylvania, OH (US)

(73) Assignee: Conti, LLC, Sterling Hts., MI (US)

(21) Appl. No.: 19/200,225

(22) Filed: May 6, 2025

(51) Int. Cl. G05B 15/02

(52) U.S. Cl. CPC G05B 15/02

(57) ABSTRACT

A building management and automation system use with large quantities of data is disclosed. The building management and automation system comprises a native database framework integration tool arranged on a host server. The system further includes an architect application arranged on the host server. The system also includes a user interface arranged on a remote computer. The user interface queries and interacts with the native database framework integration tool. The architect application requires a valid license for access and usage thereto. The building management and automation system automatically creates or adjusts new or existing folders and automatically applies new metadata, tags, tuning policies, alarms, facets, or histories to the building management and automation system. The architect application also automatically alters existing metadata, tags, tuning policies, alarms, facets or histories. The system also uses the architect application to automatically perform data management and device import for the system.

### BACKGROUND OF THE INVENTION

### 1. Field of the Invention

The present invention generally relates to database systems and more particularly, relates to a system for building management and automation having large quantities of data, the system enables efficient data driven deployments of that data.

### 2. Description of Related Art

Large database networks have been well known in the art for many years. One specific database system is the Niagara Framework, which is an integration tool that is popular in the building automation industry. The Niagara Framework database includes many features, such as single sign on with Niagara as an identity provider, enhanced graphics with tag based visualization, cloud connectivity, improved edge tools, Niagara proxy service enhancements, Niagara security history log, third party module signing, ACE on third party hardware, HTML 5 Video streaming, and cyber security updates. This Niagara Framework, which is generally used with the building automation industry is a very powerful database that integrates many functions of building automation into a single database system. However, databases, such as the Niagara Framework, do not offer out of the box unique templating, which utilizes a graphical user interface (GUI) or any other means of database replication or rapid deployment of the data within that database.

Therefore, there is a need in the art for a system that is capable of integrating with a database, such as a Niagara Framework, that is capable of using an intuitive user interface, which is designed to query and interact with the underlying Niagara Framework in the building automation industry or any other industries. There is also a need in the art for a service or application that is a bolt on tool to a Niagara Framework database that may allow for the users to seamlessly massage and manipulate large quantities of data with a single click of a button. There also is a need in the art for an application that can configure datasets within the user interface, where the datasets can be saved for future deployment. There is also a need in the art for an architect application that the user may integrate the database and select components residing under the configuration space within the Niagara Framework to perform a multitude of automated tasks. There also is a need in the art for an architect service or application that is capable of operating under a licensing model, which would require users to obtain a valid license for access to and usage of the architect application in order to bridge the gap between the users of the architect application, such as building managers, and database systems. This may enable efficient data driven deployments of the data needed to manage multiple building scenarios in the building automation industry. There also is a need in the art for a system or application that is self contained and has the necessary components and features needed for building management and the automation of those buildings in one place. Many building managers using the prior art Niagara Framework spend countless hours manually entering data into the Niagara Framework from each building in a building portfolio and then after manually entering such data had to manually manipulate that data as necessary to determine the status of the buildings and the automation features associated with each building. Therefore, there is a need in the art for an addon application to be used in conjunction with a database, such as a Niagara Framework that may automate many of the current manual functions of a building portfolio.

### SUMMARY OF THE INVENTION

One object of the present invention may be to provide an improved building management and automation system.

Another object of the present invention may be to provide a building management and automation system that is capable of operating in the Niagara Framework environment.

Still another object of the present invention may be to provide a building management and automation system that includes an architect application as an addon to a Niagara Framework.

Yet another object of the present invention may be to provide a building management and automation system that includes an architect application that is capable of automating many of the previously manually entered data and operations on that data into a Niagara Framework building management and automation system.

Still another object of the present invention may be to provide a building management and automation system that is capable of reducing the number of man hours necessary to track and manage multiple buildings in a building portfolio.

Yet another object of the present invention may be to provide a building management and automation system that operates under a licensing model, requiring users to obtain a valid licensing for access and usage to the architect application features.

According to the present invention, the foregoing and other objects and advantages are obtained by a novel methodology and system which provides a method of data normalization in a multiple building management system. The method comprises the steps of licensing a user to enable access and usage to the method. The method further comprises creating a building portfolio through an intuitive web browser interface. The method also comprises connecting over a network to an architect software module, wherein said architect software module is an addon tool used in conjunction with a Niagara Framework integration tool in the building automation industry. The method also includes the step of generating a building portfolio for each of the multiple buildings arranged within the building system, wherein those building portfolios may be automatically created and updated within the architecture app with such features, such as but not limited to, creating new folders or adjusting existing folder structure, applying new meta data or altering the existing meta data, applying new tags or altering existing tags, applying tuning policies or altering existing tuning policies, applying new alarms or altering existing alarms, applying new facets or altering existing facets, applying new histories or altering existing histories, or various data management, such as but not limited to changing slot names and changing display names and device importation, such as importing database devices for normalization as selected with the GUI.

One advantage of the present invention may be that it provides for an improved building management and automation system.

Another advantage of the present invention may be that it provides for an improved building management and automation system that includes an architect application addon to an underlying database framework, such as the Niagara Framework.

Still another advantage of the present invention may be that it provides for a building management and automation system that operates under a licensing model, which requires users to obtain a valid license for access and usage to the architecture application addon.

Yet another advantage of the present invention may be that it provides for a building management and automation system that uses an architecture application that features an intuitive user interface designed to query and interact with an underlying database, such as a Niagara Framework database.

Still another advantage of the present invention may be that it uses an architect application that allows for the configuration of data sets within the user interface that may be saved for future deployment.

Still another advantage of the present invention may be that it uses an architecture application with the building management and automation system that the user may interrogate the database and select components residing under the configuration space within the Niagara Framework to perform multitude of automated tasks that in the prior art had to be manually performed.

Yet another advantage of the present invention may to provide a building management and automation system with an architect application that is one of a kind solution that is designed with unique capabilities and features not found in the prior art. This architecture application may address specific challenges and needs while offering unparalleled functionality, design and exclusivity to innovate and create a singular tool tailored for the specialized purpose of building management and automation systems.

Other objects, features and advantages of the present invention may become apparent from the subsequent description, and the appended claims, taken in conjunction with the accompanying drawings.

### BRIEF DESCRIPTION OF THE DRAWINGS

FIG. 1 shows a prior art Niagara Framework system used in building automation systems.

FIG. 2 shows a flow chart for a building management and automation system according to the present invention.

FIGS. 3A and 3B show a flow chart for an architect application for use with the building management and automation system according to the present invention.

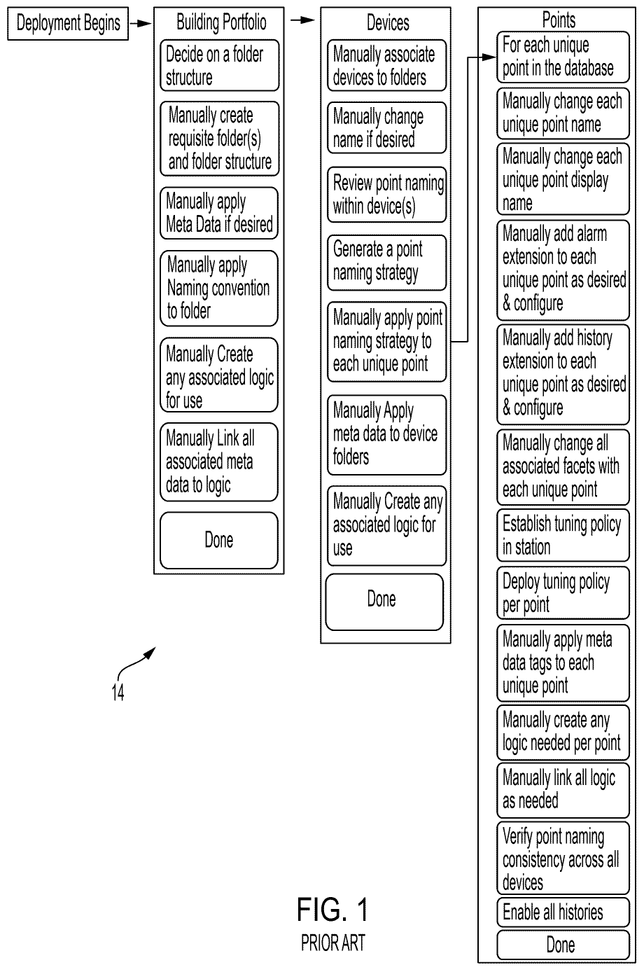

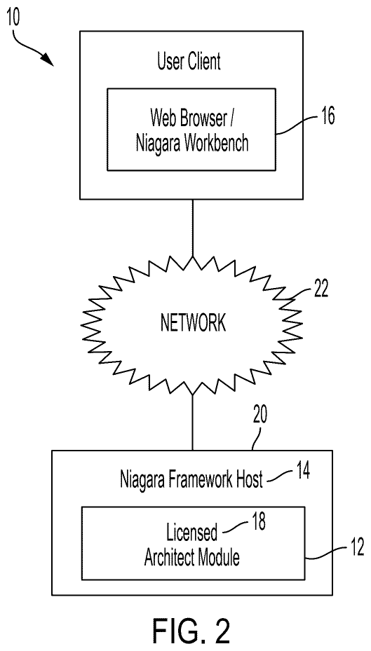

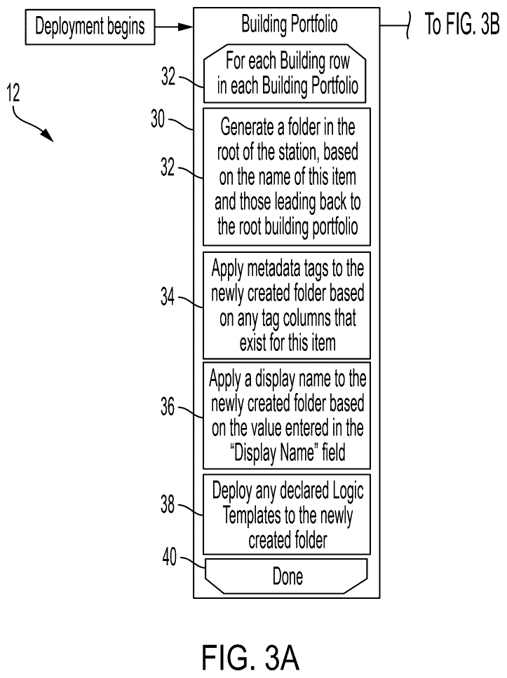

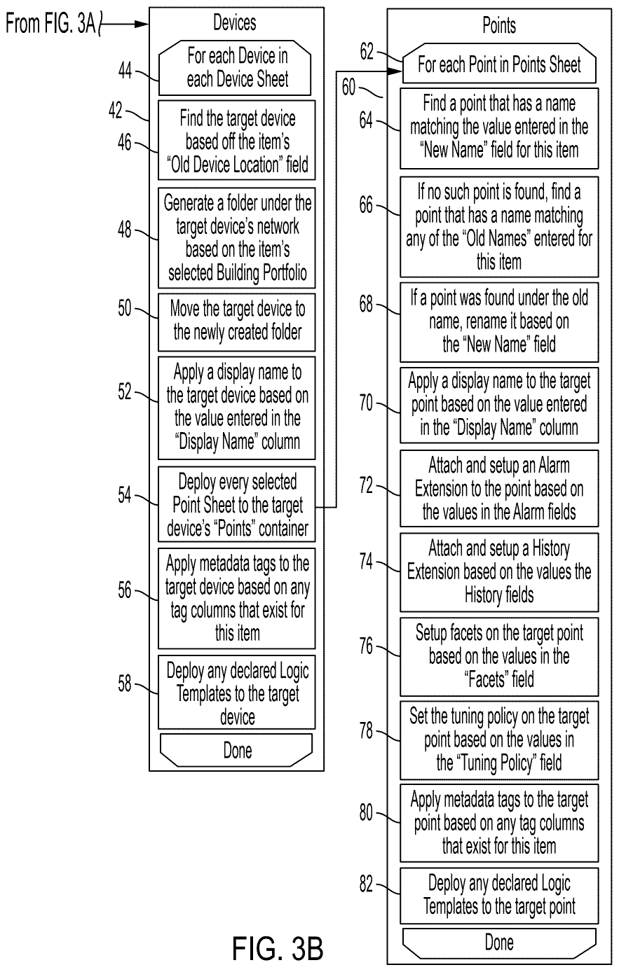

### DESCRIPTION OF THE EMBODIMENT(S)

Referring to the drawings, a building management and automation system 10 is shown according to the present invention. It should be noted that the building management and automation system 10 of the present invention may be used on any known type of structure or building and may be used on multiple or a plurality of buildings and structures in a single or multiple building portfolio. It is also contemplated that the building management and automation system 10 of the present invention may also be used in other industries other than the building management industry. The building management and automation system 10 is capable of being used in any industry that uses large volumes of data and needs to track, control and manipulate that data related to predetermined components or structures. One of the contemplated embodiments described in the present invention is for a building management and automation system 10, however any other type of system or industry that uses large data sets that need to be manipulated and organized in a quick manner may also be used with the building management and automation system 10 of the present invention. As shown in the drawings, the building management and automation system 10 of the present invention may be an addon or bolt on application, which maybe an architect service or application 12. This application 12 maybe an addon or bolt on tool to a database framework. In one contemplated embodiment, the database framework 14 may be a native Niagara Framework 14, which is an integration tool. However, the native Niagara Framework 14 does not offer out of the box unique templating which utilizes a GUI or any other means of database replication along with means of rapid deployment of the data within that database and throughout the Niagara Framework system 14. It should be noted that the present invention may be used with other databases other than the native Niagara Framework 14. The architect service or application 12 of the present invention may be able to be added on to many different databases other than the Niagara Framework 14 as disclosed herein. The architect application 12 of the present invention may feature an intuitive user interface 16 that is designed to query and interact with the underlying Niagara Framework 14 database or other chosen databases. In the architect application 12 as the user configures data sets within the user interface 16, that user may be able to save those datasets for future deployment into the building management and automation system 10 of the present invention. Furthermore, the user of the building management and automation system 10 may be able to interrogate the database 14 and select components residing under the configuration space within the Niagara Framework 14 to perform a multitude of automated tasks that in the past and in prior art systems had to be manually entered or completed, thus creating numerous man hours such as forty to sixty hours of work to enter or manipulate these data sets into a building management and automation system 10.

The novel architect application 12 of the present building management and automation system 10 may remove the necessity of manual entry of data and manual changing of folders, tags, meta data, alarms, histories, facets and tuning policies within the building management and automation system 10. The entry and manipulation of the data is automated such that the building management and automation system 10 may be capable of performing this manipulation and entry of the data in a matter of minutes versus many hours as described above. The architect application 12 may also be designed to operate under a licensing model 18. This licensing model 18 may require users to obtain a valid license for access and usage of the addon architect application 12 and associated Niagara Framework database 14. This may allow for all licenses to be issued and managed by a predetermined user, wherein the goal of using the licensing model is to be able to bridge the gap found in the prior art between the users of the building management and automation system 10 and the database systems 14 upon which they run. This may enable efficient data driven deployments in the building automation industry by use of the architect application 12, which in and of itself is a self contained system with all the necessary components and features built into that application 12 to smoothly run a multi building portfolio. Hence, the architect application 12 may be a one of a kind solution that is designed with entirely unique capabilities and features not found in any other product in the prior art or current market. This architect application 12 may address specific challenges and needs in a unique way thus offering an unparalleled functionality, design, and technology for the building automation industry. The exclusivity of the use of the architect application 12 may set it apart from all other Niagara Framework 14 uses making it an innovative and singular tool tailored for the purpose of managing and automating multiple buildings in a building portfolio or in any other industry as needed by the user of the architect application 12.

The building management and automation system 10 of the present invention may include a native database framework 14 integration tool which is arranged on a host server 20. In one contemplated embodiment this native database framework integration tool 14 may be a Niagara Framework 14, however it should be noted as stated above that any other database, other than the Niagara Framework database 14, may also be used with the present invention. The building management and automation system 10 may also include a user interface 16 which is arranged within an architect application 12. The user interface 16 may query and interact with the native database framework integration tool 14. The user interface 16 may be a remote computer, tablet, phone or other electronic device that is connected either via a hard wired or a wireless system to any type of network or internet 22. The network 22 may be any personal network, private network or public network. The network 22 is capable of connecting to a host server 20 via the internet or any other system capable of connecting a remote computer 16 to a host server 20 arranged at a different location. The architect module or application 12 may be arranged on the host server 20. In one contemplated embodiment, the user is required to have a valid license 18 for access and usage to the architect module application 12 of the building management and automation system 10 of the present invention. It should be noted that the user client may download, via the web browser the user client is using, on the remote computer, a sign on page to the building management and automation system 10 of the present invention. It should further be noted that the user client may use either a web browser 16 to connect via any known network 22 to the architect module 12 of the present invention or a Niagara workbench. The building management and automation system 10 may be used via any hand held or electronic device or any other electronic device at any known location of any building in the or out of the building portfolio in order to connect to the architect module 12 which is arranged on the host server 20, which is generally but not always at a remote location from the building portfolio. It is also contemplated that the architect module 12 may be arranged on a host server 20 that is arranged in a cloud environment, thus allowing for interconnectivity from any of the many buildings in the building portfolio 30 to the building management and automation system 10 of the present invention.

In operation, the building management and automation system 10 of the present invention may include and be used with a plurality of buildings that are associated and mated with a building portfolio 30. The buildings may be capable of being managed via automation by a single user via the building management and automation system 10 of the present invention. The building management and automation system 10 of the present invention may be capable of checking, maintaining and adjusting temperatures of HVAC units, fire systems, the locking of doors, and unlocking of doors, the monitoring of cameras and other security devices within a building of the building portfolio 30, etc. Therefore, the building management and automation system 10 may be capable of controlling, maintaining and adjusting numerous data points and devices arranged throughout numerous buildings in a building management industry organization. It should be noted that the building management and automation system 10 of the present invention may include an architect application 12 that includes three modules, however any other number of modules may also be used. The first module is the building portfolio module 30, which when complete may then pass the methodology into the device module 42, which after completion thereof may pass the methodology into the points module 60. The architect application 12 may begin its processing in a building portfolio module 30. Within the building portfolio module 30, the architect application 12 enters box 32 and may for each building arranged within in a row in each building portfolio therein, generate a folder in the root of the station, based on the name of the item and those leading back to the root building portfolio 30. Next, the application app 12 may enter box 34 and apply the metadata tags to the newly created folders based on any tag columns that exist for this particular item. Next, the architect application 12 enters box 36 and may apply a display name to the newly created folder based on the value entered in the display name field. Next, the architect application 12 enters box 38 and may deploy any declared logic templates to the newly created folder. The architect application 12 may then exit the building portfolio module 30 in the next box 40 and enter a devices module 42 of the architect application 12.

In the device module 42 of the architect application 12 enters boxes 44, 46 and for each device sheet of the building portfolio 30 the application 12 may find a target device based off the item's old device location field. The device module 42 may then in box 48 generate a folder under the target devices network based on the items selected building portfolio 30. The device module 42 may then enter box 50 and move the target device to the newly created folder. The device module 42 may then enter box 52 and apply a display name to the target device based on the value entered in the display name column. The device module 42 of the architect application 12 may then in box 54 deploy every selected point sheet to the target devices points container. Next, the device module 42 of the architect application 12 enters box 56 and applies metadata tags to the target device based on any tag columns that exist for this particular item. Next, the device module 42 may enter box 58 and deploys any declared logic templates to the target device. It should be noted that all of the instructions and commands of the device module 42 may be done automatically without any manual intervention by the user of the architect application 12. Thus, all of the instructions and commands of the device module 42 may automatically occur in a predetermined amount of time. After the methodology enters the final box of the device module 42 the architect application 12 may exit box 54 and enter a points module 60 for the architect application 12.

The methodology next enters the points module 60 from box 54 of the device module 42. In box 62 of the points module 60 for each point in the point sheet the following occurs. The application 12 enters box 64 wherein it may find a point that has a name matching the value entered in the new name field for this item. Next, the points module 60 may enter box 66 wherein if no such point was found in box 62, the methodology may find a point that has a name matching any of the old names entered for this item. Next, the points module enters box 68 and determines if a point was found under the old name and if it was, it may rename the point based on the new name field. Next, the methodology may enter box 70 and apply a display name to the target point based on the value entered in the display name column. Next, the points module 60 enters box 72 and may attach and set up an alarm extension to the point based on the values in the alarm field of the database 14. Next, the points module 60 may enter box 74 and attach and set up a history extension based on the values in the history fields. The methodology may then enter box 76 and set up facets on the target point based on the values in the facet field. The methodology may then enter box 78 and set the tuning policy on the target point based on the values in the tuning policy field. The points module 60 may then enter box 80 and apply metadata tags to the target point based on any tag columns that exist for this item. Then, the points module 60 may enter box 82 and deploy any declared logic templates to the target point. The points module 60 may then be done and the architect application 12 may look for a new deployment to begin either in the existing building portfolio 30 or a new building portfolio may be entered into the system 10.

As described above, the architect application 10 may be utilized in multiple environments including but not limited to the Niagara Framework 14. The architect application 10 as further described above includes many unique features. These unique features are not found anywhere in the prior art. These features include, but are not limited to, creating new folders or adjusting existing folder structures without manual intervention by the user of the building management and automation system 10 of the present invention. With relation to metadata, the architect application 12 may apply new metadata while also altering the existing metadata depending on the data entered. The architect application 12 may also apply new tags and alter existing tags in an automated manner throughout the system 10 in real time. The architect application 12 may also apply new tuning policies or alter existing tuning policies in real time throughout the architect application 12 and the entire building management and automation system 10. The architect application 12 may also apply new alarms or alter existing alarms while also applying new facets or altering the existing facets all in real time without manual intervention by the user of the architect application 12. The architect application 12 also includes the features of applying new histories and altering existing histories in real time. The architect application 12 may also include data management systems that allows for the changing of slot names and changing display names in real time without human intervention. The architect application 12 may also include device import such that the importing of existing database devices for normalization is selected with a GUI in real time. All of these features may be self contained in a one of a kind solution for the present invention.

Therefore, in operation the present system 10 including the architect application 12 loaded onto a host server 20, also uses a Niagara Framework database 14. This host server 20 may then be connected via any known network 22 to a remote computer 16 or any other type of handheld electronic device in order to use and access the architect application 12 according to the present invention. The building management and automation system 10 of the present invention may then require the purchase of a license agreement to access the architect application 12 and all of its features in operating and managing a multi building portfolio. Once a license is purchased the user of the building management and automation system 10 of the present invention may be able to sign into the architect application 12 and upload data relating to the multiple buildings in the building portfolio and multiple building portfolios. The architect application 12 may then automatically update many features such as metadata, tags, tuning polices, alarms, facets, histories, data management and device import without the need for manual input of data or information into the database itself. Thus, the building management and automation system 10 of the present invention may greatly reduce the number of man hours needed to manage a portfolio of multiple buildings and/or make changes to the building portfolios buildings in regard to locks, doors, HVAC systems, and the like throughout all buildings in the building portfolio 30.

The present invention has been described in an illustrative manner. It is to be understood that the terminology, which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A method of automating data normalization in a multiple building management and automation system, said method comprising the steps of:
licensing a user to enable access and usage to a software module;
creating a data set through a web browser interface;
connecting over a network to said software module, said software module is an add on tool used in conjunction with a database framework integration tool; and
generating a building portfolio for each of the multiple buildings.

2. A method of claim 1 further comprising the step of finding a target device for each of said buildings in said building portfolio by said old device location field.

3. The method of claim 1 further comprising the step of generating a folder in a root of a station of said framework based on a name.

4. The method of claim 3 further comprising the step of applying metadata tags and a display name to said folder.

5. The method of claim 4 further comprising the step of deploying declared logic templates to said folder.

6. The method of claim 2 further comprising the step of generating a first folder under said target devices network based on said building selected in said building portfolio.

7. The method of claim 6 further comprising the step of moving said target device to said first folder.

8. The method of claim 7 further comprising the step of applying a first display name and metadata tags to said target device.

9. The method of claim 8 further comprising the step of deploring declared logic templates to said target device and deploying a selected point sheet to said target devices points container.

10. The method of claim 9 further comprising the step of finding for each point in said point sheet a name that matches the value entered in a new name field for a first item.

11. The method of claim 10 wherein if each point is not located then finding for said each point a name matching any old name for said first item.

12. The method of claim 11 wherein if said each point is located under said old name then renaming said each point based on said new name field.

13. The method of claim 12 further comprising the step of applying a display name to said each point.

14. The method of claim 13 further comprising the step of attaching and setting up an alarm extension and a history extension to said each point.

15. The method of claim 14 further comprising the step of setting facets on said each point.

16. The method of claim 15 further comprising the step of setting a tuning policy on said each point.

17. The method of claim 16 further comprising the step of applying metadata tags to said each point for any tag columns for said first item.

18. The method of claim 17 further comprising the step of deploying said declared logic templates to said each point.

19. A system for use with large quantities of data, the system allows users to seamlessly use database systems in an efficient data driven deployment, said system comprising:
a native database framework integration tool arranged on a host server;
an architect application arranged on said host server;
a user interface arranged on a remote computer controls and manipulates said architect application, said user interface queries and interacts with said native database framework integration tool;
said architect application requires a valid license for access and usage; and
said architect application automatically creates or adjusts new or existing folders, said architect application automatically applies new metadata, tags, tuning policies, alarms, facets, or histories, said architect application automatically alters existing metadata, tags, tuning policies, alarms, facets or histories, said architect application automatically performs data management and device import.

20. The system of claim 19 wherein said native database is a Niagara Framework, the system is for use with building automation and control management.
